(19) United States
(12) Patent Application Publication
(10) Pub. No.: US 2023/0166461 A1
(43) Pub. Date: Jun. 1, 2023

(54) Apparatus and Method for Forming Arbitrarily-Shaped Fiber-Bundle-Based Preforms

(71) Applicant: Arris Composites Inc., Berkeley, CA (US)

(72) Inventors: Christopher Bender, Oakland, CA (US); Maxwell Harshorn Shimshak, Oakland, CA (US); Gary Alan Hogue, Berkeley, CA (US); J. Scott Perkins, Oakland, CA (US)

(21) Appl. No.: 17/994,368

(22) Filed: Nov. 27, 2022

Related U.S. Application Data
(60) Provisional application No. 63/283,942, filed on Nov. 29, 2021.

(51) Int. Cl. B29C 70/52; B29C 31/08; B29C 33/04

(52) U.S. Cl. CPC B29C 70/528; B29C 31/08; B29C 33/04; B29C 70/526; B29K 2105/0881

(57) ABSTRACT

An apparatus for forming a fiber-bundle-based preform from a preform precursor material includes a process head coupled to a robotic arm. The process head has at least two rollers, a heated region, and a cooled region. A length of preform precursor material is passed through the rollers and fixed at a first end thereof. The process head moves relative to the preform precursor material, following a path defined by the movement of the robotic head. The path comports with the desired shape of the fiber-bundle-based preform. As the process head moves, it softens a portion of the preform precursor material, which then passes through the two rollers, the combination thereof incrementally altering the shape of preform precursor material to that of the preform. After passing the rollers, the newly formed region of preform is cooled to set its shape. The process head continues to move relative to the preform precursor material until the preform is fully formed.

### STATEMENT OF RELATED CASES

This specification claims priority of U.S. 63/283,942 filed Nov. 29, 2021 and incorporated by reference herein.

### FIELD OF THE INVENTION

The present invention relates to the molding processes, and, more particularly, to the preparation of a feed constituent for compression-molding processes.

### BACKGROUND

Applicant’s compression-molding processes, such as described for example in US 2020/0171763, are based on the use of fiber-bundle-based preforms (“FBB preforms”). These FBB preforms consist of a bundle of plural, co-aligned, same-length, resin-wetted fibers. The plural fibers in each bundle are typically present in multiples of a thousand (e.g., 1k, 10k, 24k, etc.). The fibers align with the major axis of their host preform.

The FBB preforms are sourced from towpreg or a resin-impregnation process (hereinafter “preform precursor material”), and are often formed in specific shapes for each product that is to be molded. Whatever the source, the fiber bundles, and hence the resulting FBB preforms, typically have a substantially circular cross section. Thus, the aspect ratio (width-to-thickness) of the cross section is usually close to about 1:1. FBB preforms are thus distinguished from prior-art feed constituents (regardless of whether they are referred to as “preforms”), including those that have relatively flat form factors, such as tape/ribbon (typically having an aspect ratio -cross section, as above- of between about 10 to about 30), (ii) sheets of fiber, (iii) cuttings from sheets of fiber, and (iv) laminates.

Currently, the FBB preform manufacturing process is limited to angular bending with a small radius at each bend, often resulting in polygonal shapes preforms. Some of the more complicated-shape preforms are prepared using plural bends, which collectively achieve a large bend radius. The polygonal nature of the preforms often requires concessions elsewhere in the manufacturing process, such as the use of larger cavities in compression molds or in preform-charge fixtures (i.e., fixtures that create assemblages of the preforms for placement in compression molds), or requiring the use of smaller-diameter filament. For some projects, this forming process cannot produce suitable preforms.

Additionally, controlling the cross-sectional shape of the preform precursor material can be difficult, and the standard filament having a round cross section is not an ideal shape for all applications.

### SUMMARY

The invention provides a way to form FBB preforms that avoids some of the costs and disadvantages of the prior art. Embodiments of the invention provide a way to fabricate FBB preforms having an arbitrary shape from straight lengths of preform precursor material (“PPM”). Moreover, in some embodiments, the cross-sectional shape of the PPM can be altered as desired.

In some embodiments, an apparatus for forming FBB preforms includes a process head comprising two rollers, a heater, a cooler, arranged to provide relative motion between the process head and the PPM. In the illustrative embodiment, relative motion is provided via a robotic arm. In operation, the process head heats the PPM to the point at which it is malleable, and then acts upon the heated material to reshape it into a desired form.

Using applicant’s existing processes, PPM is typically held in tension for processing. This is not the case for embodiments of the invention. Consequently, and among any other distinctions, the apparatus does not require an additional materials-handling mechanism to create such tension. And unique in comparison to other processes that shape/position precursor materials for subsequent molding operations, embodiments of the invention form the preforms in free space, unconstrained by a mold or other shaping means.

### BRIEF DESCRIPTION OF THE DRAWINGS

FIG. 1 depicts a system for forming a fiber-bundle-based preform having an arbitrary shape and cross section in accordance with an illustrative embodiment of the invention.

FIG. 2 depicts detail of a process head of the system of FIG. 1.

FIG. 3 depicts detail of roller of the process head of FIGS. 1 and 2.

FIG. 4 depicts a block diagram of a method for forming a fiber-bundle based preform in accordance with an illustrative embodiment of the invention.

### DETAILED DESCRIPTION

Definitions. The following terms are defined for use in this description and the appended claims:
“Tow” means a bundle of fibers (i.e., a fiber bundle), and those terms are used interchangeably herein unless otherwise specified. Tows are typically available with fibers numbering in the thousands: a 1K tow, 4K tow, 8K tow, etc.
“Prepreg” means fibers that are impregnated with resin.
“Towpreg” means a fiber bundle (i.e., a tow) that is impregnated with resin.
“Fiber-bundle-based preform” or “FBB preform” means a bundle of plural, co-aligned, same-length, resin-wetted fibers. The plural fibers in each bundle are typically present in multiples of a thousand (e.g., 1k, 10k, 24k, etc.). The fibers align with the major axis of their host preform. The bundle is often (but not necessarily) sourced from a long length of towpreg. That is, the bundle is a segment of towpreg that has been cut to a desired size and, in many cases, is shaped (e.g., bent, twisted, etc.) to a specific form, as appropriate for the specific part being molded. Alternatively, the bundle of fibers can be sourced directly from impregnation processes, as known to those skilled in the art. Whatever the source, the fiber bundles, and hence the FBB preforms, typically have a substantially circular cross section. Thus, the aspect ratio (width-to-thickness) of the cross section is usually close to about 1:1. FBB preforms are thus distinguished from prior-art feed constituents, such as BMC (bulk molding compound), SMC (sheet molding compound), as well as feed constituents having relatively flat form factors, such as (i) tape/ribbon (typically having an aspect ratio -cross section, as above- of between about 10 to about 30), (ii) sheets of fiber, (iii) cuttings from sheets of fiber, and (iv) laminates.
“Consolidation” means, in the molding/forming arts, that in a grouping of fibers/resin, void space is removed to the extent possible and as is acceptable for a final part. This usually requires significantly elevated pressure, either through the use of gas pressurization (or vacuum), or the mechanical application of force (e.g., rollers, etc.), and elevated temperature (to soften/melt the resin).
“Partial consolidation” means, in the molding/forming arts, that in a grouping of fibers/resin, void space is not removed to the extent required for a final molded part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.
“Compression molding” is a molding process that involves the application of heat and pressure to feed constituents for a period of time. For applicant’s processes, the applied pressure is usually in the range of about 500 psi to about 3000 psi, and temperature, which is a function of the particular resin being used, is typically in the range of about 150° C. to about 400° C. Once the applied heat has increased the temperature of the resin above its melt temperature, it is no longer solid. The resin will then conform to the mold geometry via the applied pressure. Elevated pressure and temperature are typically maintained for a few minutes. Thereafter, the mold is cooled and then pressure is withdrawn. A finished part is then removed from the mold.
“About” or “Substantially” means +/- 20% with respect to a stated figure or nominal value.
Other definitions are provided elsewhere in this specification in context.

### Preform Precursor Material

Preforms precursor material (PPM) is typically sourced from towpreg, but may also be sourced from the output of a resin impregnation line. The PPM, typically in the form of a bundle with a circular cross section, includes thousands of co-aligned, resin-infused fibers, typically in multiples of one thousand (e.g., 1k, 10k, 24k, etc.).

The individual fibers can have any diameter, which is typically, but not necessarily, in a range of 1 to 100 microns. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of composition, each individual fiber can be, for example and without limitation, carbon, carbon nanotubes, glass, natural fibers, aramid, boron, metal, ceramic, polymer, synthetic fibers, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing. Non-limiting examples of suitable synthetic fibers include nylon (polyamides), polyester, polypropylene, meta-aramid, para-aramid, polyphenylene sulfide, and rayon (regenerated cellulose).

Any resin -thermoplastic or thermoset- that bonds to itself under heat and/or pressure can be used in conjunction with embodiments of the invention.

Exemplary thermoplastic resins useful in conjunction with embodiments of the invention include, without limitation, acrylonitrile butadiene styrene (ABS), ethylene tetrafluoroethylene (ETFE), fluorinated ethylene propylene (FEP), liquid crystal polymers (LCPs), polyamides (Nylon), polyaryletherketones (PAEK), polybenzimidazole (PBI), polybutylene terephthalate (PBT), polycarbonates (PC), and polycarbonate-ABS (PC-ABS), polyethylene (PE), polyetheretherketone (PEEK), polyetherimide (PEI), polyether sulfones (PES), polyethylene terephthalate (PET), perfluoroalkoxy copolymer (PFA), polyimide (PI), polymethylmethacrylate (PMMA), polyoxymethylene (polyacetals) (POM), polypropylene (PP), polyphosphoric acid (PPA), polyphenylene ether (PPE), polyphenylene oxide (PPO), polyphenylene sulfide (PPS), polyphenylsulfone (PPSU), Polystyrene (PS), polysulfone (PSU), polytetrafluoroethylene (PTFE), polyurethane (PU), polyvinyl chloride (PVC), styrene acrylonitrile (SAN), and styrene butadiene styrene (SBS). A thermoplastic can be a thermoplastic elastomer such as polyurethane elastomer, polyether ester block copolymer, styrenic block copolymer, polyolefin elastomer, polyether block amide, thermoplastic olefins, elastomeric alloys (TPE and TPV), thermoplastic polyurethanes, thermoplastic copolyesters, thermoplastic polyamides, and thermoplastic silicone vulcanizate.

Non-limiting examples of suitable thermosets include araldite, bakelites, epoxies, melamines, phenol/formaldehydes, polyesters, polyhexahydrotriazines, polyimides, polyisocyanates, polyureas, silicones, urea/formaldehydes, vinyl esters, phenolics, and polycarbonates. Suitable thermosets can be prepared as a partially cured B-stage.

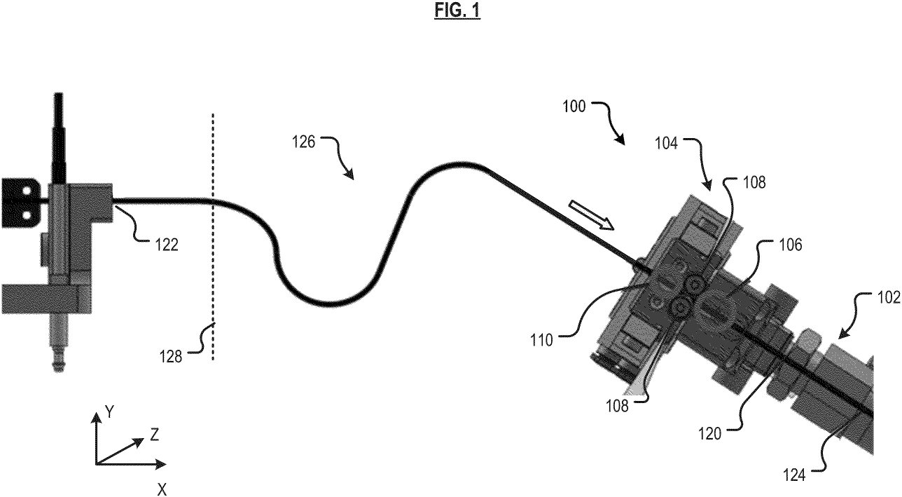

FIG. 1 depicts system 100 for forming arbitrary-shaped preforms in accordance with the illustrative embodiment of the invention. In this context, the term “arbitrary” is used to signify that the preform can be formed into literally any shape, and most notably include smooth bends, including smooth bends with a relatively small radius of curvature (high degree of curvature).

The salient elements of system 100 include robotic arm 102 and process head 104, coupled to one another as shown. Only the distal end of robotic arm 102 is depicted in FIG. 1. Moving through free space, as guided by robotic arm 102, process head 104 shapes preform 126 from a straight length of PPM 120.

Robotic arm 102 provides relative motion between process head 104 and PPM 120. To form 2D-preform shapes, relative motion between PPM 120 and process head 104 is required in X, Y, and θ (which is rotation around Z) directions. In order to form 3D-preform shapes, all six degrees of freedom (DOF) are required (X, Y, Z, and rotation around each of those axes).

In the illustrative embodiment, a 6 DOF robotic arm is used. Process head 104 is mounted to robotic arm 102, and PPM 120 is held stationary during processing.

In other embodiments, the 6 DOF are divided in various combinations between PPM 120 and process head 104, but such systems are more complicated than system 100 depicted in FIG. 1. For example, in an embodiment of the invention in which the system has a stationary process head, it would be necessary to move PPM 120 in increasingly longer moves as processing proceeds. And in embodiments in which a 180° bend is created in the FBB preform, the point at which PPM 120 is held must be moved along an involute path from one side of process head 104 to the other. For a system that is creating 2D FBB preforms, PPM 120 can be moved in the X and Y directions, and process head 104 moved in the θ direction.

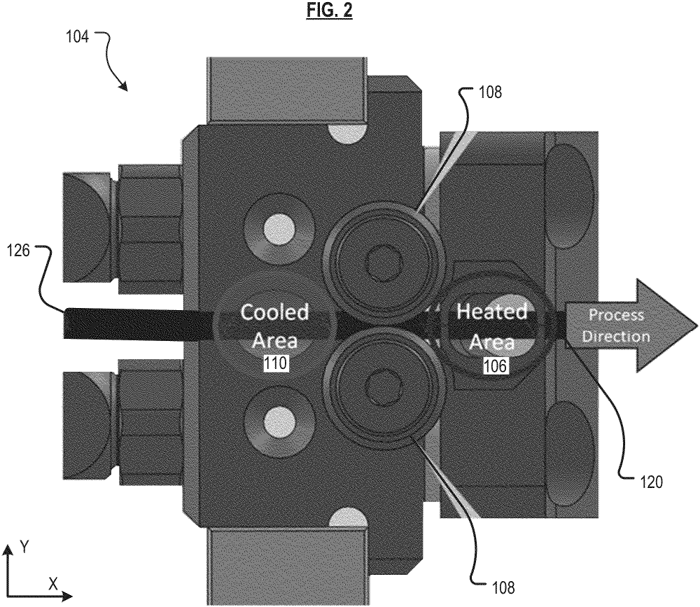

Referring to FIG. 1 and FIG. 2, process head 104 includes heated region 106, rollers 108, and cooled region 110. These regions are encircled in the Figures.

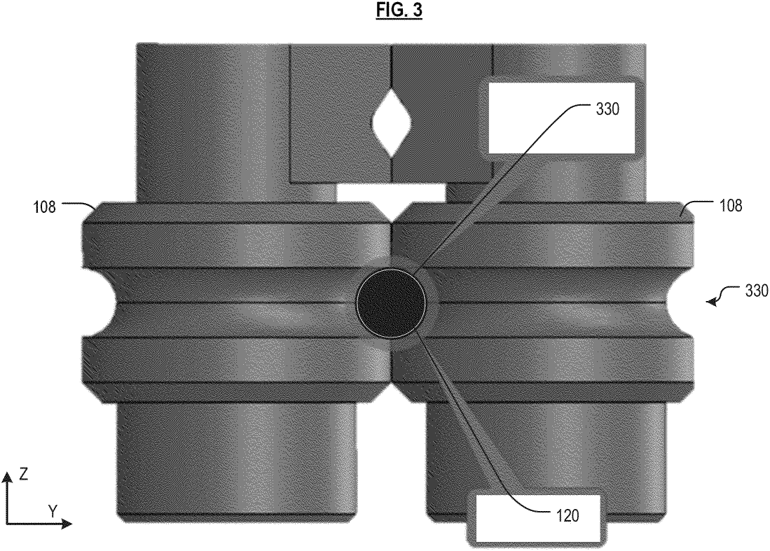

Referring additionally to FIG. 3, Rollers 108 are mounted to be tangent to each other, and one or both of rollers 108 include at least one groove 330 that is matched in size to the diameter of PPM 120, so that the PPM can pass through the opening that is created between the two rollers. The minimum achievable inside radius at any location of the preform being formed is equal to the outside radius of the grooved portion of the roller(s).

In some embodiments, a groove deep enough to accommodate the full diameter of PPM 120 is present in one of rollers 108; in the depicted embodiment, each roller 108 accommodates a “hemisphere” of PPM 120 (i.e., one half of the cross section of PPM 120).

Rollers 108 are formed from a material that can withstand the heat of processing (i.e., the temperature at which PPM 120 softens), limit the friction between the mechanical process components and PPM 120, and inhibit adhesion of PPM 120 to rollers 108. Suitable material includes, without limitation, stainless steel with precision features and a high polish.

In the illustrative embodiment, rollers 108 are free spinning. However, in some embodiments, rollers 108 are driven to further reduce friction effects. In the illustrative embodiment, rollers 108 are mounted to pneumatic grippers (not depicted), which enable the two rollers 108 to be moved towards or away from one another. This enables process head 104 to engage with and disengage from PPM 120.

Heated region 106 results in the heating of PPM 120 on one side of rollers 108. Heated region 106 is heated by a heater (not depicted). In some embodiments, the heater is implemented as a hot-air blower, which directs hot air through channels within process head 104. In some embodiments, the heater blows hot air through a nozzle (not depicted) that encapsulates a section of PPM 120, heating that specific section only, providing precise process control. In some other embodiments, the heater is implemented as a laser, which, relative to hot air, will heat PPM 120 more quickly, efficiently, and accurately.

A short length of PPM 120 will be exposed to the heat at any given time, wherein that length and the heater power dictate the achievable processing speed. In embodiments in which PPM 120 is held stationary, the “hot side” (i.e., the side on which heated region 106 is located) is “in front” of the rollers in the direction (indicated by the “arrow” in FIG. 1) that process head 104 moves.

It is desirable for the heater to apply sufficient power so that PPM 120 is brought rapidly to processing temperature. It is within the capabilities of those skilled in the art to design and supply a heater suitable for heating PPM 120 at a desired rate.

Cooled region 110 maintains rollers 108 and other elements of process head 104 at a temperature well below the processing temperature of PPM 120. Moreover, in some embodiments, cooled region 110 is implemented to cools the resulting FBB preform 126 directly, if necessary to balance the process. In this context, FBB preform 126 is what exits rollers 108.

In some embodiments, cooled region 110 is implemented by providing pressurized air or other gas that is at or below room temperature (i.e., about 20° C.) to the portions of process head 104 that must remain relatively cool. In some embodiments, this is accomplished via channels (not depicted) within process head 104. In some other embodiments, this is implemented via external tubing, etc. In some embodiments, the pressurized air or other gas can also be piped directly to preform 126 as it exits rollers 108. In some other embodiments, ambient air is relied upon to passively cool preform 126.

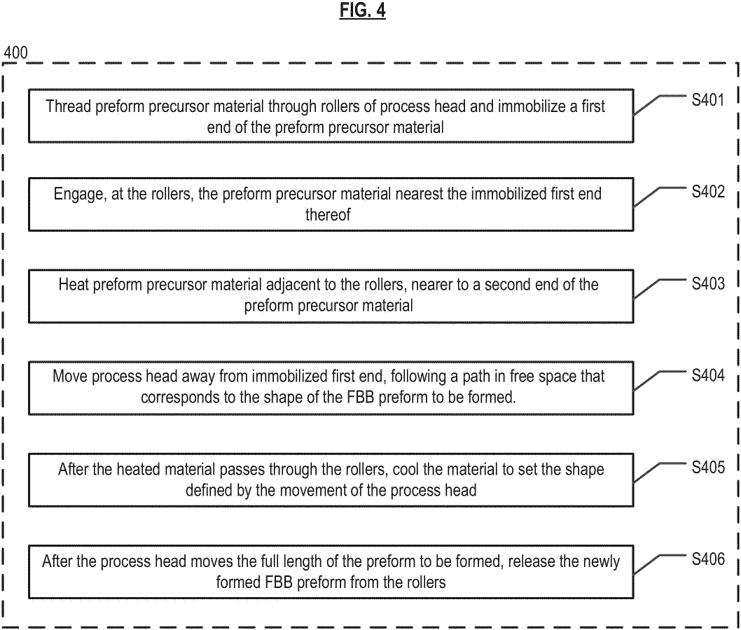

FIG. 4 depicts method 400 for forming an arbitrary-shape preform in accordance with the present teachings. In operation S401, a length of PPM 120, corresponding in some embodiments to the total length of the preform being created, is fed from a spool of stock material (not depicted), threaded through rollers 108, and fixed in place at one end (see, e.g., FIG. 1, end 122).

In some alternative embodiments, a length of PPM 120 is fed that corresponds to a section of the preform, and sequential forming operations are performed. Such alternative embodiments are implemented through certain architectural modifications that are within the capabilities of those skilled in the art, in light of this specification.

At operation S402, rollers 108 engage PPM 120 as close as possible to fixed end 120, for example at engagement point 128 (see FIG. 1).

At operation S403, PPM 120 adjacent to rollers 108 is heated to the process temperature. In operation S404, process head 104 then begins moving through space, tracing the shape of the preform to be created. The rotation of the process head is constantly adjusted such that the axis defined as the line that is always equidistant from the centers of each roller (hereinafter the “process axis”) is tangent to the preform curve at that position.

As process head 104 moves (based on the movement of robotic arm 102, PPM 120, now heated and malleable, passes through rollers 108. This has the effect of reconfiguring the formerly linear PPM 120 into the desired shape of FBB preform 126.

Due to ambient air cooling or pressurized air directed at it, and the (prior) contact with rollers 108, the newly formed portion of FBB preform 126 cools to below the processing temperature, such that its new shape is set, per operation S405. Meanwhile, PPM 120 from unconstrained end 124 is constantly entering heated area 106 and is heated to processing temperature. When the motion speed of process head 104, the heating rate, and the cooling rate are all in balance, material passing through system 100 (as the head is moving) is always hot and malleable as it enters the space between the rollers, but cool and solid by the time it exits. As discussed further below, if the cross-sectional shape of groove 330 (FIG. 3) in rollers 108 is different than the cross-sectional shape of PPM 120, FBB preform 126 will have a different cross-sectional shape than the PPM on which it’s based.

In accordance with operation S406, a FBB preform is formed after process head has traversed a requisite length. In embodiments in which the starting length of PPM 120 is approximately equal to that of FBB preform being formed, then the process head will traverse substantially the full length of PPM 120. In such an embodiment, process head 104 continues moving forward a small amount so that there is no longer any PPM 120 between rollers 108. If the starting length of PPM 120 is substantially longer than newly formed FBB preform 126, rollers 108 are separated (e.g., automatically via grippers) to release the FBB preform.

The newly formed preform is then cut away from PPM 120 at engagement location 128 (i.e., near to fixed end 122), and transported away, such as to be used in forming a preform charge (i.e., an assemblage of preforms that is placed in a mold). There will be a small section of PPM 120 just beyond rollers 108 on the cool side thereof that may not be part of preform 126. In such scenarios, preform 126 is cut from PPM 120 at this location, as well as at engagement point 126.

As previously mentioned, system 100 is capable of altering the cross section of the FBB preform relative to that of PPM 120 from which it is formed. Thus, beginning with PPM having a circular cross section (or a cross section that lends it to easy spooling/storage), the cross section of resulting FBB preform is altered as desired.

This can be advantageous, for example, for the preform-charge assembly process. More particularly, for use in molding a part in accordance with applicant’s processes, FBB preforms are organized into an assemblage. The assemblage has a geometry and shape that is typically close to that of the part being molded. In some embodiments, the assemblage is formed by placing the FBB preforms, one-by-one, into the mold. In some other embodiments, the FBB preforms are first organized into a “preform charge” and then placed in the mold.

In a preform charge, the plurality of FBB preforms that are “tacked” together. The term “tacking” references heating to the point of softening (but not melting) to effectively join the FBB preforms so as to create a single structure. In some cases, minimal compression is applied for tacking. The preform charge, which is often created in a special fixture, conforms to the shape of the mold (and hence the part), or portions of it. Because the resin in the FBB preforms is not heated to liquefication (the FBB preforms are typically heated to a temperature that is above the heat deflection temperature of the resin, but below the melting point), and the applied pressure is typically low (less than 100 psig and in some cases nothing more than the force of “gravity” acting on the FBB preforms), the preform charge is not fully consolidated and thus could not function as a finished part. But once joined in this fashion, the preforms will not move, thereby maintaining the desired geometry and the specific alignment of each preform in the assemblage. See, e.g., Publ. Pat. App. US2020/0114596 and U.S. Pat. App. SN 16/877,236.

Consider a part, or a portion thereof, having a rectangular cross section. If the cross section of the PPM is not altered, FBB preforms having a circular cross section will be formed. Such FBB preforms pack inefficiently, resulting in a substantial amount of void space in a given volume of the mold. Consequently, the mold will need to larger (i.e., deeper, etc.) to accommodate the greater number of preforms required than would be the case if the preforms could pack more efficiently. Moreover, utilizing embodiments of the invention, FBB preforms can be formed from large-diameter PPM with a cross section that is altered to match that of the part being formed. In such a case, the “assemblage” of preforms could simply include one or two preforms of rectangular cross-section in that region of the mold. This will decrease the number of pick-and-place operations required during the preform-charge assembly process, reducing the cycle time and cost of the final part.

Thus, the FBB preforms formed via system 100 will have a cross section that corresponds to the profile of groove 330 in rollers 108 (FIG. 3). Thus, if the opening collectively formed by groove 330 in the two rollers is “square,” the resulting FBB preform will have a square cross section, even though the PPM had a circular cross section. In such a case, groove 330 in each roller 108 will have a rectangular profile with a width equal to the diameter of the PPM, and a depth equal to half of that. The resulting opening will have a larger cross-sectional area than the round PPM material being fed to it. It will be appreciated that the cross-sectional area of the PPM and the opening formed by the grooves must be properly matched (i.e., substantially equal to one another).

Consequently, in embodiments in which the desired cross-section of the FBB preform is significantly different from the PPM, multiple sets of rollers are used. The first set of rollers reshapes the PPM slightly, with each subsequent set of rollers creating a cross-section that is closer to the final desired cross-section. Typically, each subsequent set of rollers defines an opening having a cross sectional area somewhat smaller than the opening defined by the previous set of rollers. The final set of rollers creates a preform having the desired cross-section. In some such embodiments, all of the rollers are involved in the shaping (e.g., curving forming) of the preform. In some other of such embodiments, only the final set of rollers is involved in preform shaping.

In some embodiments, multiple lengths of PPM are fed through an appropriately sized set of rollers and thereby fused together to create a single larger-diameter FBB preform.

It is to be understood that the methods and materials described herein are useful for enhancing the impact resistance of any composite part and at any location of the part. Furthermore, any one or more of the arrangements, methods, and materials described above can be used together to enhance impact resistance.

What is claimed:

1. An apparatus for forming a fiber-bundle-based preform from a preform precursor material, the apparatus comprising:
a robotic arm;
a process head coupled to the robotic arm, wherein the process head includes:
(a) A first roller having a first axis of rotation, and a second roller having a second axis of rotation, wherein the first axis of rotation and the second axis of rotation are parallel to and offset from one another, and wherein there is a circumferential groove in at least one of the first and second rollers, wherein the at least one circumferential groove defines a first opening having a cross-sectional area at least as large as an area of a cross section of the preform precursor material;
(b) a heated region, wherein the heated region is disposed on a first side of the first and second rollers;
(c) a cooled region, wherein the cooled region is disposed on a second side of the first and second rollers; and wherein
the process head is physically adapted to receive a length of the preform precursor material that is fixed at a first end proximal to the second side of the first and second rollers, and untethered at second end that is proximal to the first side of the first and second rollers, and wherein the composite precursor material passes through the circumferential groove.

2. The apparatus of claim 1 wherein the robotic arm has six degrees of freedom.

3. The apparatus of claim 1 further comprising a hot-air blower for creating the heated region.

4. The apparatus of claim 3 wherein the process head includes channels, and wherein hot air from the hot-air blower passes through the channels that lead to the heated region.

5. The apparatus of claim 3 wherein the heated region comprises a nozzle that receives hot air from the hot air blower.

6. The apparatus of claim 1 wherein the heated region receives laser light from a laser.

7. The apparatus of claim 1 wherein the cooled region receives pressurized air that is at or below room temperature.

8. The apparatus of claim 1 wherein a perimeter of first roller and a perimeter of the second roller abut one another.

9. The apparatus of claim 1 wherein the first opening has a shape defined by the at least one circumferential groove, wherein the shape of the first opening and a shape of the cross section of the preform precursor material are substantially the same.

10. The apparatus of claim 1 wherein the first opening has a shape defined by the at least one circumferential groove, wherein the shape of the first opening and a shape of the cross section of the preform precursor material are different.

11. The apparatus of claim 10 comprising at least a third roller and a fourth roller, wherein there is a circumferential groove in at least one of the third roller and the fourth roller, wherein the at least one circumferential groove in the third and further rollers defines a second opening having a cross-sectional area smaller than the cross-sectional area of the first opening.

12. The apparatus of claim 1 wherein the first roller and the second roller are not driven.

13. A method for forming a fiber-bundle-based preform having a first shape and a first length from a linear portion of preform precursor material, the method comprising:
(a) fixing one end of the preform precursor material;
(b) heating a portion of the preform precursor material;
(c) passing the heated portion of the preform precursor material between two rollers while moving the two rollers in free space; and
(d) repeating steps (b) and (c), to create a fiber-bundle-based preform having the first length, and wherein the movement through free space creates the first shape.

14. The method of claim 13 comprising cooling the portion of the preform precursor material after the portion exits the two rollers.

15. The method of claim 13 comprising changing a shape of a cross section of the preform precursor material as the preform precursor material passes through the two rollers.
